(19) United States
(12) Patent Application Publication
(10) Pub. No.: US 2007/0139383 A1
(43) Pub. Date: Jun. 21, 2007

(54) Touch inductive key

(75) Inventor: Stephen Chen, Shengang Shiang (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 11/304,804

(22) Filed: Dec. 16, 2005

(51) Int. Cl. G09G 5/00

(52) U.S. Cl. 345/168

(57) ABSTRACT

The present invention relates to a touch inductive key, and more particularly to a key that is able to give out a response prompt when senses finger touching it so as to improve the input accuracy and decrease the frequency user required glancing at the key. The key is a pressure activated key, which comprises a key entity, and a touch inductive panel on top of the key entity connecting to a response system so that it is able to allow the user to know the character of the key under the finger through the response prompt generated by the response system when he or she touches the touch inductive panel so as to improve the inputting accuracy and decrease the frequency of glancing at the keys.

### BACKGROUND OF THE INVENTION

1. Field of the Invention

The present invention relates to a touch inductive key, and more particularly to a key that is able to give out a response prompt when senses finger touching it so as to improve the input accuracy and decrease the frequency user required glancing at the key.

2. Description of the Related Art

For character inputting, the industry has provided numerous solutions and apparatuses to satisfy different usage needs, e.g., hand writing, keyboard (key), remote control, etc. However, among which, the best inputting interface for inputting most characters remains to be key, for example, the keys on the computer keyboard and the keys on mobile phone are the fastest and handiest manipulating methods for inputting characters.

Moreover, for an amateur typist, the biggest complaint is that he or she needs to lower his or her head to glance at the keyboard to look for or confirm the inputted character keys, and then to raise his or her head again to look at the monitor to examine the correctness of the characters just inputted, especially when switching among more than two different languages. For example, when inputting Japanese, Chinese, and English at the same time, the same key is used to inputting English, Japanese or Chinese under different conditions, so the user needs to frequently lower his or her head to concentrate on the keys, and then after a series of characters raises his or her head to find out that mistakes were made. In addition, if the keys are too small or the lighting condition is too dark, it may not be easy to distinguish the keys on the keyboard and influences the speed and convenience of character inputting.

Besides, the inputting methods are limited by the symbols printed on the keyboard, e.g., the phonetic symbols, Chang-Chieh codes, Da-Yi codes, and English letters commonly printed on a Taiwanese keyboard, so it is often unable to accomplish the inputting tasks if we want to input Japanese, Korean, or other non-English or non-Chinese characters since there is no such symbol printed on the keyboard.

### SUMMARY OF THE INVENTION

Therefore, in view of the above problems, the inventor proposes a touch inductive key in accordance with the present invention. The main objective of the present invention is to provide a touch inductive key that is able to generate a response prompt when senses finger touching it. The key is a pressure activated key, which comprises a key entity, and a touch inductive panel on top of the key entity connecting to a response system so that it is able to allow the user to know the character of the key under the finger through the response prompt generated by the response system when he or she touches the touch inductive panel so as to improve the inputting accuracy and decrease the frequency of glancing at the keys.

The touch inductive panel according to the preferred embodiment of the present invention is a resistance-type pressure inductive panel.

The touch inductive panel according to the preferred embodiment of the present invention is a capacitance-type pressure inductive panel.

The key entity according to the preferred embodiment of the present invention is a resistance-type pressure inductive panel.

The key entity according to the preferred embodiment of the present invention is a capacitance-type pressure inductive panel.

The touch inductive panel according to the preferred embodiment of the present invention composes a single inductive area that generates the same character no matter which part of the touch inductive panel touched by the finger.

The touch inductive panel according to the preferred embodiment of the present invention divides the single inductive area into several sections so that, when the finger is placed on the touch inductive panel, it is able to generate different characters or input different instructions depending upon which section the finger placed, i.e., using a single key to replace the functions of several keys.

The response system according to the preferred embodiment of the present invention provides voice prompt or monitor displayed prompt.

The response system according to the preferred embodiment of the present invention is activated when the finger touches the touch inductive panel and switched off when the finger moves away from the touch inductive panel.

If the prompt provided by the response system according to the preferred embodiment of the present invention is a voice prompt, it generates the pronunciation of the character through the amplifier after the key is pressed so as to allow the manipulations of people with bad eyesight or the blind.

If the prompt provided by the response system according to the preferred embodiment of the present invention is a monitor displayed prompt, it displays the character on the default location of the monitor after the key is pressed.

The monitor displayed prompt according to the preferred embodiment of the present invention is to generate an on-screen keyboard on the default location of the monitor and the character of the pressed key is shown in special color or diagrammatically marked, and, furthermore, a block appears on top of the on-screen keyboard to indicate the character just inputted.

The monitor displayed prompt according to the preferred embodiment of the present invention is to generate a partial on-screen keyboard on the default location of the monitor and the character of the pressed key is shown in special color or diagrammatically marked.

The monitor displayed prompt according to the preferred embodiment of the present invention is to generate a partial on-screen keyboard on the default location of the monitor adjacent to the character of the pressed key near where the character is inputted, and the character of the pressed key is shown in special color or diagrammatically marked.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a preferred embodiment of the present invention;

FIG. 2 is the flow chart of the operating procedures according to a preferred embodiment of the present invention;

FIG. 3 is a structural view of the display generated by the response system according to a preferred embodiment of the present invention;

FIG. 4 is a structural view of the second preferred embodiment of the present invention;

FIG. 5 is the flow chart of the operating procedures according to the second preferred embodiment of the present invention;

FIG. 6 is a structural view of the third preferred embodiment of the present invention;

FIG. 7 is a structural view of the display generated by the response system according to the second preferred embodiment of the present invention;

FIG. 8 is a structural view of the display generated by the response system according to the third preferred embodiment of the present invention;

FIG. 9 is a structural view of the display generated by the response system according to the fourth preferred embodiment of the present invention;

FIG. 10 is a structural view of the display generated by the response system according to the fifth preferred embodiment of the present invention; and

FIG. 11 is a block view of the preferred embodiment of the present invention;.

### DESCRIPTION OF THE PREFERRED EMBODIMENTS

Hereinafter, the components and preferred embodiments according to the present invention will be described in detail with reference to the accompanying drawings.

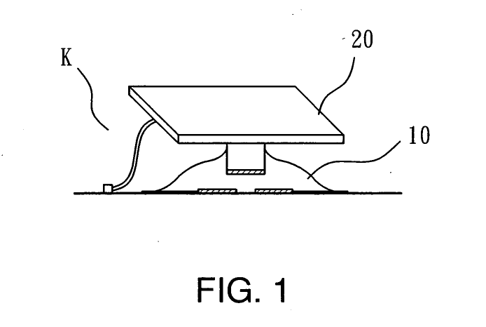

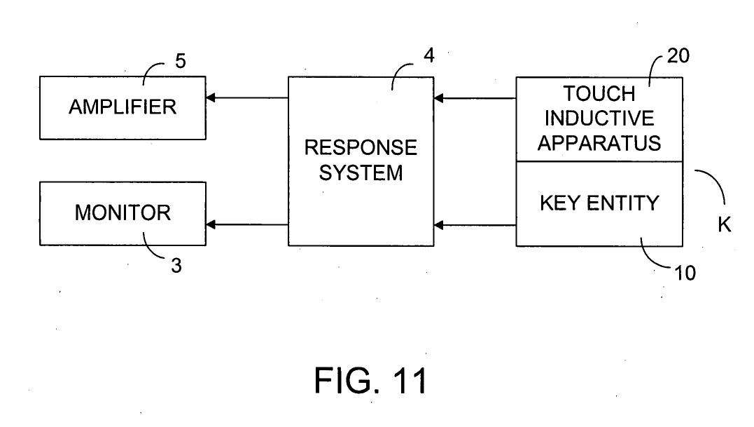

First, referring to FIG. 1 and FIG. 11, the present invention is a touch inductive key which is a pressure-activated key K comprising a key entity 10, a touch inductive panel 20 on top of said key entity 10 connecting to a response system 4, wherein:

Said key entity 10 is the interface of inputting characters by the way of finger pressing;

Said tough response panel 20 activates said response system 4 by detecting the finger touch.

Said response system 4 in accordance with the present invention could be software that is activated by the detection of finger touch though said tough inductive panel 20, and said response system 4 stops when the finger moves away from said tough inductive panel 20. Said response system 4 either gives out the pronunciation of the pressed character through an amplifier 5 so as to allow the manipulations of people with bad eyesight or the blind or displays the corresponding character at where the character is inputted on the monitor for the user to verify.

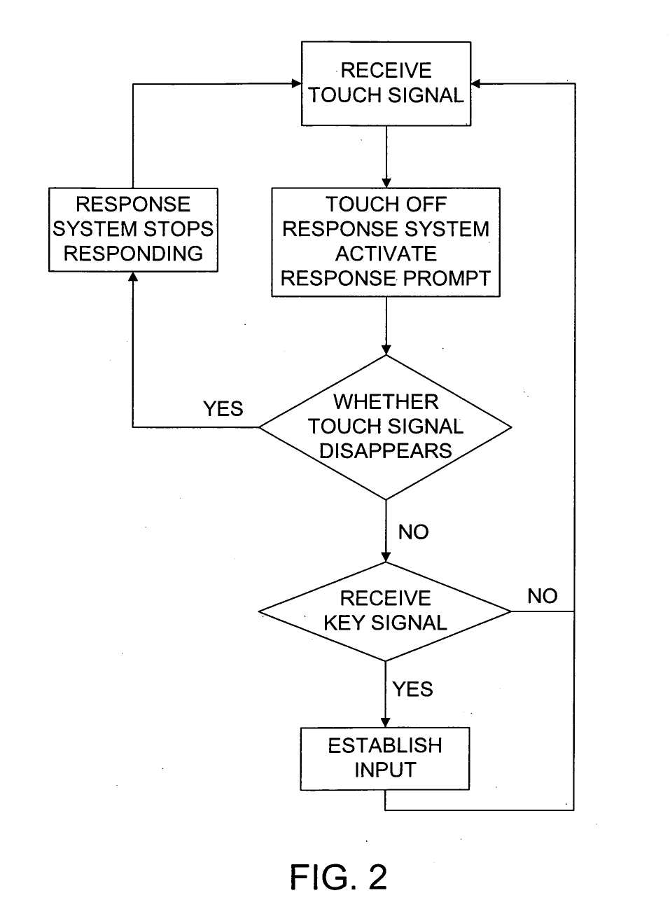

By the way of composing the above-mentioned components, the operating procedures according to the present invention are listed as follows, as referring to FIG. 2, 3, 11:

Step 1

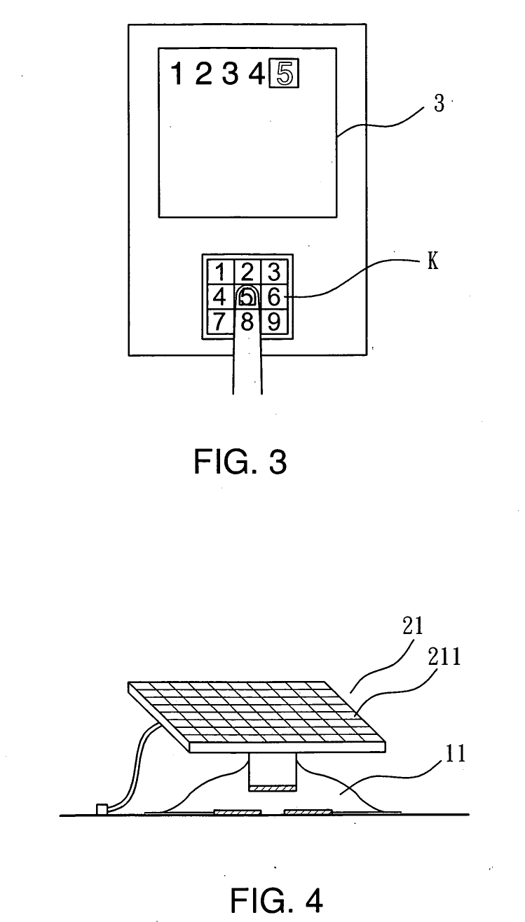

Receive touch signal: said tough inductive panel 20 is touched by the finger and produces a signal, wherein, as shown in FIG. 3; the character is number 5 when the finger touches key K.

Step 2

Touch off response system and activate response prompt: said response system 4 generates input prompt and gives out the pronunciation of the character of said key K through said amplifier 5 so as to allow the manipulations of people with bad eyesight or the blind or displays the character of said key K at where the character is inputted on the monitor 3 (as shown in FIG. 3, the symbol 5 appeared on said monitor 3) so that the user doesn't have to lower his or her head to verify.

Step 3

Whether touch signal disappears: whether the finger touch signal received by said touch inductive panel 20 disappears, if yes then go to step 6, if not step 4.

Step 4

Receive key signal: whether the finger firmly pressed said key entity 10, if yes go to step 5, if not return to step 1.

Step 5

Establish input: if the key input is established, return to step 1.

Step 6

Response system stops responding: when the touch signal disappears and after a set delay period said response system 4 stops responding, return to step 1.

As shown in FIG. 4, a structural view of the preferred embodiment of the present invention, the purpose of the present invention is to provide a multiple key input requirement, e.g., the input of characters through keyboard or mobile phone key, wherein said touch inductive panel 21 virtually divides said single touch inductive panel 21 into several sections 211 corresponding to the key chart so that when the finger touches said touch inductive panel 21, depending on the different location the finger placed on said sections 211 to generate different character inputs or different function instruction inputs.

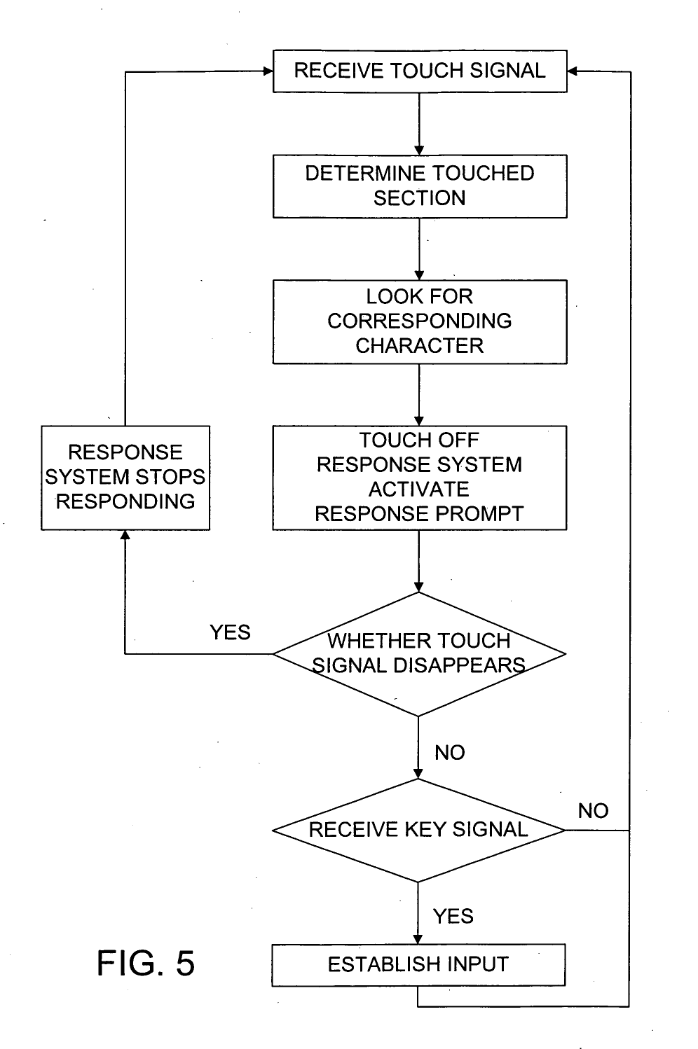

The operating procedures are listed as follows (as shown in FIG. 5):

Step 1

Receive touch signal: said tough inductive panel 21 receives finger touch signal.

Step 2

Determine touched section: determine which said section 211 of said touch inductive panel 21 the finger touches.

Step 3

Look for corresponding character: find the corresponding character through the software set character corresponding to said section 211.

Step 4

Touch off response system and activate response prompt: said response system 4 generates input prompt and gives out the pronunciation of the character of said key K through said amplifier 5 so as to allow the manipulations of people with bad eyesight or the blind or displays the character of said key K at where the character is inputted on the monitor 3.

Step 5

Whether touch signal disappears: whether the finger touch signal received by said touch inductive panel 21 disappears, if yes then go to step 8, if not step 6.

Step 6

Receive key signal: whether the finger firmly pressed said key entity 11, if yes go to step 7, if not return to step 1.

Step 7

Establish input: if the key input is established, return to step 1.

Step 8

Response system stops responding: when the touch signal disappears and after a set delay period said response system 4 stops responding, return to step 1.

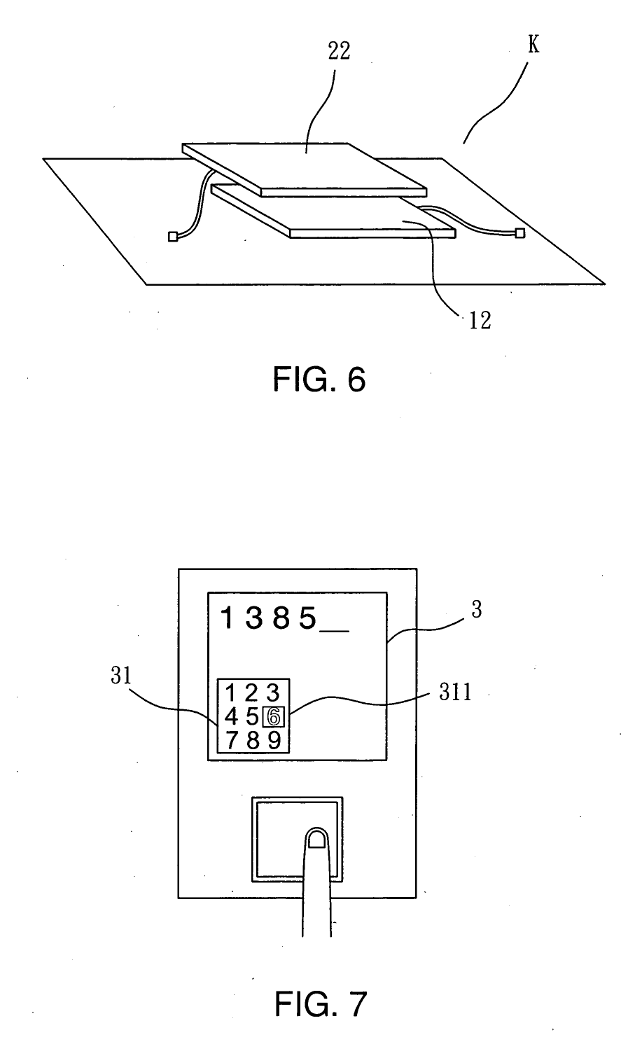

Please refer to FIG. 6, a structural view of the third preferred embodiment of the present invention, wherein said key entity 12 and said touch inductive panel 22 which can be a resistance-type pressure inductive panel or capacitance-type pressure inductive panel in order to reduce the product volume.

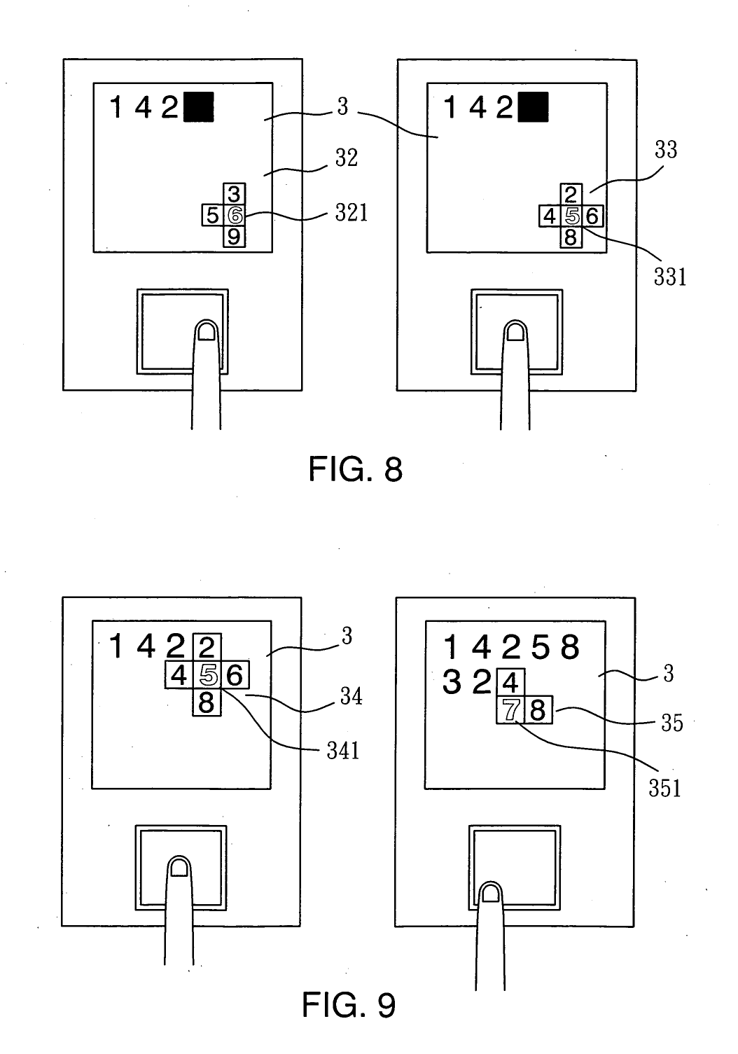

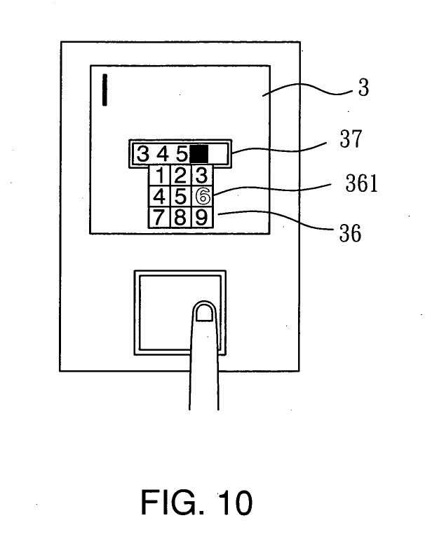

Furthermore, said response system 4 according to the preferred embodiment of the present invention not only simply provides voice prompt or monitor displayed prompt, but also supports various monitor display methods so that the user is able to quickly verify the inputted characters. An example according to the present invention will be described in detail:
A. As shown in FIG. 7, it is to generate an complete on-screen keyboard 31 on the default location of said monitor 3 and said character 311 of finger touched section is shown in special color or diagrammatically marked on said complete on-screen keyboard 31.
B. As shown in FIG. 8, it is to generate a partial on-screen keyboard 32, 33 on the default location of said monitor 3 and said character 321, 331 of finger touched section is shown in special color or diagrammatically marked on said partial on-screen keyboard.
C. As shown in FIG. 9, it is to generate a partial on-screen keyboard 34, 35 near the cursor indicating inputted character on said monitor 3 and said character 341, 351 of finger touched section is shown in special color or diagrammatically marked on said partial on-screen keyboard.
D. As shown in FIG. 10, it is to generate a complete on-screen keyboard 36 where a block 37 is on top of said complete on-screen keyboard 36 to indicate the character just inputted, and said character 361 of finger touched section is shown in special color or diagrammatically marked on said complete on-screen keyboard.
As conclusion, the present invent is able to improve the convenience of user input not only for the manipulations of ordinary users but also for the character inputting of the visual impaired, and, moreover, to allow a single key for inputting different characters through different software variably corresponding sections.

I claim:

1. A touch inductive key, which is a pressure activated key, comprising:
a key entity, and
a touch inductive panel on top of said key entity connecting to a response system, wherein
said key entity is the interface of inputting characters by the way of finger pressing;
said touch inductive panel activates said response system by detecting the finger touch.

2. The touch inductive key as set forth in claim 1, wherein said touch inductive panel is a resistance-type pressure inductive panel.

3. The touch inductive key as set forth in claim 1, wherein said touch inductive panel is a capacitance-type pressure inductive panel.

4. The touch inductive key as set forth in claim 1, wherein said touch inductive panel is a resistance-type pressure inductive panel.

5. The touch inductive key as set forth in claim 1, wherein said touch inductive panel is a capacitance-type pressure inductive panel.

6. The touch inductive key as set forth in claim 1, wherein said touch inductive panel composes a single inductive area that generates the same character no matter which part of said touch inductive panel touched by the finger.

7. The touch inductive key as set forth in claim 1, wherein said touch inductive panel divides the single inductive area into several sections so that, when the finger is placed on said touch inductive panel, it generate different characters or input different instructions depending upon which said section the finger placed.

8. The touch inductive key as set forth in claim 1, wherein the prompt of said response system is a voice prompt.

9. The touch inductive key as set forth in claim 1, wherein the prompt of said response system is switched on when the finger touches said touch inductive panel and switched off when the finger moves away from said touch inductive panel

10. The touch inductive key as set forth in claim 1, wherein said response system is a monitor displayed prompt.

11. The touch inductive key as set forth in claim 10, wherein said monitor displayed prompt is to generate a partial on-screen keyboard on the default location of said monitor and the character of the pressed key is shown in special color or diagrammatically marked.

12. The touch inductive key as set forth in claim 10, wherein said monitor displayed prompt is to generate a partial on-screen keyboard adjacent to the character of the pressed key near the cursor of inputted character.

13. The touch inductive key as set forth in claim 10, wherein said monitor displayed prompt is to generate an on-screen keyboard on the default location of said monitor and the character of the pressed key is shown in special color or diagrammatically marked.

14. The touch inductive key as set forth in claim 13, wherein there is a block on top of said on-screen keyboard to display the character just inputted.
